(19) United States
(12) Patent Application Publication
(10) Pub. No.: US 2014/0088873 A1
(43) Pub. Date: Mar. 27, 2014

(54) Networked Sensor Devices And Systems

(71) Applicant: Daryl R. Miller, Rancho Santa Margarita, CA (US)

(72) Inventor: Daryl R. Miller, Rancho Santa Margarita, CA (US)

(73) Assignee: Lantronix, Inc., Irvine, CA (US)

(21) Appl. No.: 14/034,330

(22) Filed: Sep. 23, 2013

Related U.S. Application Data
(60) Provisional application No. 61/704,117, filed on Sep. 21, 2012.

(51) Int. Cl. G01D 11/00

(52) U.S. Cl. CPC G01D 11/00
USPC 702/4

(57) ABSTRACT

A device or system of devices that integrates sensors with wired or wireless communication technologies is presented. More particularly, devices and systems for lightning detection and the dissemination of lightning data over wired or wireless networks are described. The device is a communication jack that houses a communication port, a sensor and a sensor data server. The server is coupled with both the port and the sensor and is configured to obtain sensor data from the sensor and provide access to the sensor data via the communication port. The system is a plurality of such communication jacks distributed over a geographic range.

### FIELD OF THE INVENTION

The field of the invention is sensor technologies.

### BACKGROUND

The disclosed technology generally relates to devices and systems that integrate sensors with wired or wireless communication technologies, and more particularly, to devices and systems for lightning detection and the dissemination of lightning data over wired or wireless networks.

Lightning sensor and data acquisition systems are used to detect the occurrence and determine the location of lightning discharges, and to gather and disseminate data about the discharges. For example, in a traditional “ground-based” lightning detection system, a plurality of sensors are scattered geographically in order to remotely detect the electric and magnetic fields of lightning discharges for direction and strength. Additionally, these systems use triangulation or attenuation to determine location data of the discharges. Lightning detector networks are used by meteorological services worldwide and by other organization such as electrical utilities companies, air traffic control and forest fire prevention services.

Thus far, lightning detection systems have several known limitations. Those systems that use triangulation to determine location data must be able to detect a lightning discharge with at least three, disparately located sensors in order for the discharge to be located within an acceptable margin of error. This often leads to the rejection of cloud-to-cloud lightning, as one sensor might detect the position of the strike on the starting cloud and the other sensor the receiving one. As a result, triangulation-based systems have a tendency to underestimate the number of discharges, especially at the beginning of storms where cloud-to-cloud lightning is most prevalent.

Alternatively, lightning detection systems that use attenuation, rather than triangulation, to determine location sometimes mistakenly indicate a weak lightning strike nearby as a strong lightning strike far away, or vice-versa.

Space-based lightning systems have since been developed to address these limitations. These expensive space-based systems, deployed on artificial satellites, can locate range, bearing and intensities of lightning discharges by direct observation. However, the information provided by space-based systems is often several minutes old by the time it is widely available, making it of limited use for real-time applications such as air navigation and weather warning systems.

Others have put forth effort towards developing systems and methods of detecting lightning data and disseminating lightning data more accurately, quickly and cost effectively. Unfortunately, these known lightning detection systems use proprietary protocols or application specific modules, making them difficult to integrate with preexisting standards and infrastructures.

For example, U.S. Pat. No. 6,791,311 to Murphy titled “Lightning Detection and Data Acquisition System,” issued Sep. 14, 2004, discusses a plurality of remote programmable sensors utilized to detect lightning strikes, convert analog representations of lightning data to digital signals, and then disseminate the digital signals across a network. Murphy, however, does not teach the coupling of a sensor data server to a sensor and a communication port within a common modular housing or compatible with popular or open communications standards. U.S. Pat. No. 5,699,245 to Herold entitled “Distributed Lightning Detection System,” issued Dec. 16, 2007, further contemplates using modulation as a communication channel for a wide area lightning detection system. Still, Herold does not specifically discuss using alternative, popular or open wired or wireless communication schemes such as cellular. U.S. Pat. No. 8,005,617 to Koste titled “System and Method for Detecting Lightning Strikes Likely to Affect a Condition of a Structure,” issued Aug. 23, 2011, discusses data logging for lightning strikes. Unfortunately, Koste fails to provide insight into a modular combined sensor and communication jack that can disseminate the logged data over a wired or wireless network.

The applicant has appreciated that sensors can be combined with communication technologies as a single modular unit, thus providing an efficient, cost effect lightning detector with wide compatibility.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Even though the above references are useful for their intended purposes, they do not address circumstances where a large network of sensor devices must be deployed at low cost with compatibility with preexisting standards or infrastructure. Thus there is a need to provide devices and systems for low-cost, highly modular sensor systems to make critical sensor data widely available in a timely manner.

### SUMMARY OF THE INVENTION

The present invention is directed to devices, systems and methods in which one can measure near real-time sensor data, including strength and spatial coordinates of sensor data, using one or more sensors integrated with wired or wireless communication technologies.

To this end in an exemplary embodiment, a communication jack comprising: a jack housing comprising mounting points; a communication port disposed within the jack housing; a sensor at least partially disposed within the housing; and a sensor data server disposed within the housing and coupled with the communication port and the sensor, the server configured to obtain sensor data from the sensor and provide access to the sensor data via the communication port.

In another exemplary embodiment, wherein the sensor comprises a lightning sensor.

In another exemplary embodiment, wherein the sensor comprises at least one of the following: a camera, a hall effect sensor, a thermometer, a global positioning system (UPS) sensor, a mechanical sensor, a chemical sensor, a biometric sensor, a microphone, an accelerometer, a pressure sensor, a compass, a magnetometer, a touch display, an optical sensor, a proximity sensor, a vibration sensor, a piezoelectric sensor, a capacitive sensor, a resistive sensor, and a weight sensor.

In another exemplary embodiment, wherein the housing comprises a Faraday housing.

In another exemplary embodiment, wherein the mounting points comprise at least one of the following: ground pins, tabs, and surface mounting points.

In another exemplary embodiment, wherein the communication jack further comprises a sensor input interface.

In another exemplary embodiment, wherein the sensor input interface comprises an antenna.

In another exemplary embodiment, wherein the housing operates as the sensor input interface.

In another exemplary embodiment, wherein the communication port comprises a registered jack (RJ) network interface.

In another exemplary embodiment, wherein the RJ network interface comprises at least one of the following: an RJ11 jack, an RJ14 jack, an RJ21 jack, RJ48 jack, and an RJ45 jack.

In another exemplary embodiment, wherein the communication port comprises a wired port.

In another exemplary embodiment, wherein the wired port comprises at least one of the following: an Ethernet port, a serial port, an RS-232 port, an RS-485 port, RS-422 port, a USB port, a FireWire port, a fiber channel, a camera link, a Thunderbolt port, an PCI Express, an IEEE-488 connector, an WEE-1284 parallel port, a UNI/O bus, a process field bus (PROFIBUS), an ACCESS-bus, a MIDI interface, an Inter-Integrated Circuit (I 2C), and a serial peripheral interface bus (SPI).

In another exemplary embodiment, wherein the communication port comprises a wireless port.

In another exemplary embodiment, wherein the wireless port operates according to at least one of the following: radio, cellular, TETRA, P25, OpenSky, EDACS, DMR, dPMR, DECT, WPAN, Bluetooth, ultra-wideband (UWB), RFID, TransferJet, Wireless USB, DSRC, EnOcean, near field communication (NFC), wireless LAN, Wi-Fi, HiperLAN, IEEE 802.11, WMAN, LMDS, WiMAX and HiperMAN

In another exemplary embodiment, wherein the server comprises at least one of the following: an FTP server, an HTTP server, an application server, a communications server, a database server, a fax server, a file server, a device server, a name server, a print server, a proxy server, a web server, and an analytics server.

In an exemplary embodiment, a lightning detection system comprising: a plurality of communication jacks, each jack including a communication port and a lightning sensor at least partially disposed in a common jack housing having mounting point; and at least one server coupled with the plurality of communication jacks and configured to provide access to lightning sensor data from the lightning sensor via the communication port of at least one of the plurality of communication jacks.

In another exemplary embodiment, wherein the common jack housing comprises a Faraday housing.

In another exemplary embodiment, wherein at least one of the communication jacks further comprises a sensor input interface.

In another exemplary embodiment, wherein the housing operates as the sensor input interface.

In another exemplary embodiment, wherein the communication port comprises a registered jack (RJ) network interface.

One possible embodiment of the inventive subject matter is a communication jack comprising (1) a jack housing with mounting points, (2) a communication port disposed within the jack housing, (3) a sensor at least partially disposed within the housing, and (4) a sensor data server disposed within the housing. The sensor data server is coupled with both the communication port and the sensor and is configured to obtain sensor data from the sensor, providing access to the sensor data via the communication port.

In preferred embodiments, the sensor comprises a lightning sensor. In alternative embodiments, the sensor comprises any other type of appropriately sized sensor that can both be disposed in the housing and interface with the server.

The housing may be a Faraday housing. The mounting points may comprise ground pins, tabs or surface mount points.

In some embodiments, the communication jack may further comprise one or more sensor input interfaces. The interfaces could be in the form of antennas. Alternatively, the housing itself could operate as an interface.

In preferred embodiments, the communication port comprises a registered jack (RJ) network interface such as an RJ11 jack, an RJ14 jack, an RJ21 jack, an RJ48 jack, or an RJ45 jack. In other embodiments, the communication port may be any alternative wired or wireless port.

In some embodiments, the sensor data server is configured to associate capture sensor data with metadata, where the metadata can include time stamps, GPS coordinates, seismography data, weather conditions, or any other information that can be brought to bear during the analysis of lightning discharge data. For example, common embodiments may associate time data with one or more sensor data points. Such time stamps can later be used to determine sensor data trends over time.

In still other embodiments, the sensor data server is configured to obtain external data from the communication port. Such data may in turn be used to affect the state, position or orientation of the sensor. Additionally, the data could be combined with sensor data to provide analysis.

The sensor data server could also be configured to encrypt and/or decrypt data transferred between the communication port, the sensor and the sensor input interface. Alternatively, the communication jack may comprise a dedicated cryptography engine configured to encrypt and/or decrypt data transferred between the communication port, the sensor, the sensor data server and the sensor input interface.

The communication port could be configured to translate, convert, compress or amplify data obtained from the sensor data server, server, server input interface, or external sources. Alternatively, the communication jack may comprise a dedicated translation engine configured to translate, convert, compress or amplify data transferred between the communication port, the sensor, the sensor data server, the sensor input interface, the cryptography engine, or external sources.

The inventive subject matter also includes a lightning detection system. The lightning detection system comprises a plurality of communication jacks. Each jack includes a communication port and a lightning sensor that are at least partially disposed in a common jack housing having one or more mounting points. Additionally, at least one server is coupled with the plurality of communication jacks and configured to provide access to lightning sensor data from the lightning sensor via the communication port of at least one of the plurality of communication jacks.

In this system, the common jack housings of one or more of the communication jacks can be a Faraday housing. At least one of the communication jacks could also comprise a sensor input interface. Such an interface could be in the form of an antenna. Alternatively, the housing of the communication jack could, itself, operate as the interface.

One or more of the communication jacks could have a communication port that is an RJ network interface (RJ11, RJ14, RJ21, RJ48, RJ45, etc.). Alternatively, one or more communication ports could be a different wired or wireless port standard.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a general schematic of a sensor technology within the inventive subject matter.

FIG. 2 is a general schematic of a lightning detection system.

### DETAILED DESCRIPTION

It should be noted that while the following description is drawn to a computer/server based sensor analysis systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including the integration of a sensor with a wired or wireless communication technology within a small, modular housing.

Such size and modularity enables mass distribution of the device and the integration of the sensor and communication technology enables wide scale, near real-time dissemination of sensor data. Mass distribution of the networked sensor devices also provides improved methods of gathering information on the strength, location or spatial triangulation of sensory data, further improving forecasting and conditions reporting.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

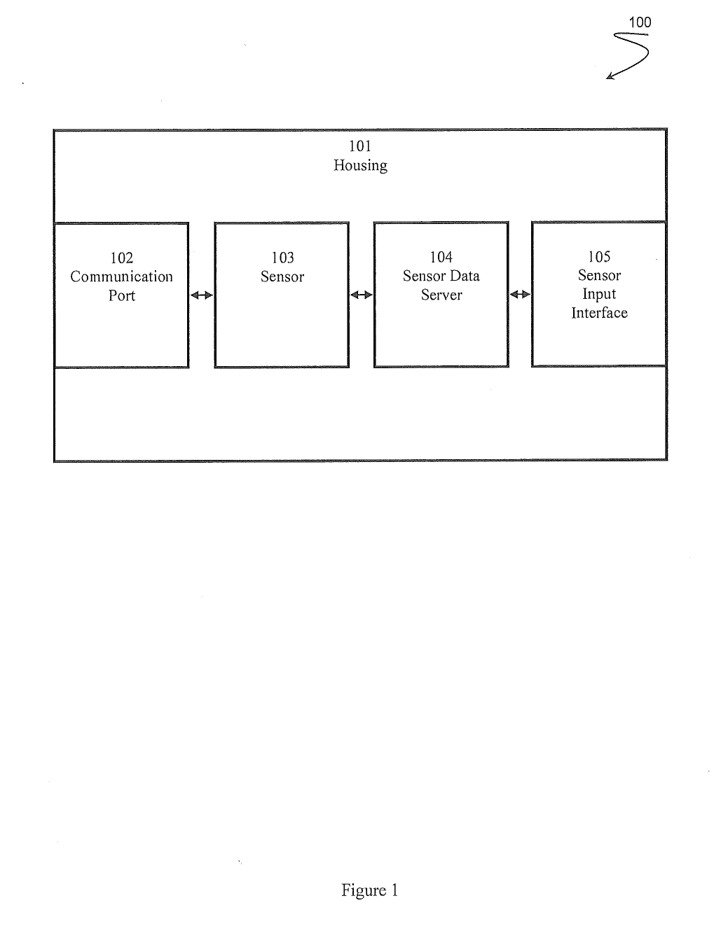

In FIG. 1, a communication jack 100 is presented where a communication port 102, a sensor 103, a sensor data server 104 and a sensor input interface 105 are all, at least partially, disposed within a housing 101.

One should appreciate that the housing 101 could be a Faraday housing and could be made of any plastic, metal or other material suitable for housing the sensor, server and communication ports. The housing 101 can have mounting points such as ground pins, tabs or surface mounting points. In preferred embodiments, the housing is sized appropriately to house all components described herein and shown in FIG. 1, but is also of a modular or portable size such that it can be widely disseminated and easily installed.

In preferred embodiments, communication jack 100 may have a communication port 102 comprising a registered jack (RJ) network interface such as an RJ11 jack, an RJ14 jack, an RJ21 jack, an RJ48 jack or an RJ45 jack.

Alternatively, the communication port 102 could be any other type of wired port such as an Ethernet port, a serial port, an RS-232 port, an RS-485 port, an RS-422 port, a USB port, a FireWire port, a fiber channel, a camera link, a Thunderbolt port, a PCI Express port, an IEEE-488 connector, an IEEE-1284 parallel port, a UNI/O bus, a process field bus (PROFIBUS), an ACCESS-bus, a MIDI interface, an Inter-Integrated Circuit (I 2C), or a serial peripheral interface bus (SPI).

The communication port 102 could also be a wireless port. The wireless port could operate according to at least one of the following wireless standards: radio, cellular, TETRA, P25, OpenSky, EDACS, DMR, dPMR, DECT, WPAN, Bluetooth, ultra-wideband (UWB), RFID, TransferJet, Wireless USB, DSRC, EnOcean, near field communication (NFC), wireless LAN, Wi-Fi, HiperLAN, IEEE 802.11, WMAN, LMDS, WiMAX or HiperMAN.

In preferred embodiments, the sensor 103 may comprise a lightning sensor (e.g. Austria Micro Systems AS3935 integrated Lightning Sensor IC or similar). Alternatively the sensor 103 may be any other type of small sized sensor such as a camera, a hall effect sensor, a thermometer, a global positioning system (GPS) sensor, a mechanical sensor a chemical sensor, a biometric sensor, a microphone, an accelerometer, a pressure sensor, a compass, a magnetometer, a touch display, an optical sensor, a proximity sensor, a vibration sensor, a piezoelectric sensor, a capacitive sensor, a resistive sensor or a weight sensor.

The sensor data server 104 could be one of many types of servers such as an FTP server, an HTTP server, an application server, a communications server, a database server, a fax server, a file server, a device server, a name server, a print server, a proxy server, a web server, or an analytics server.

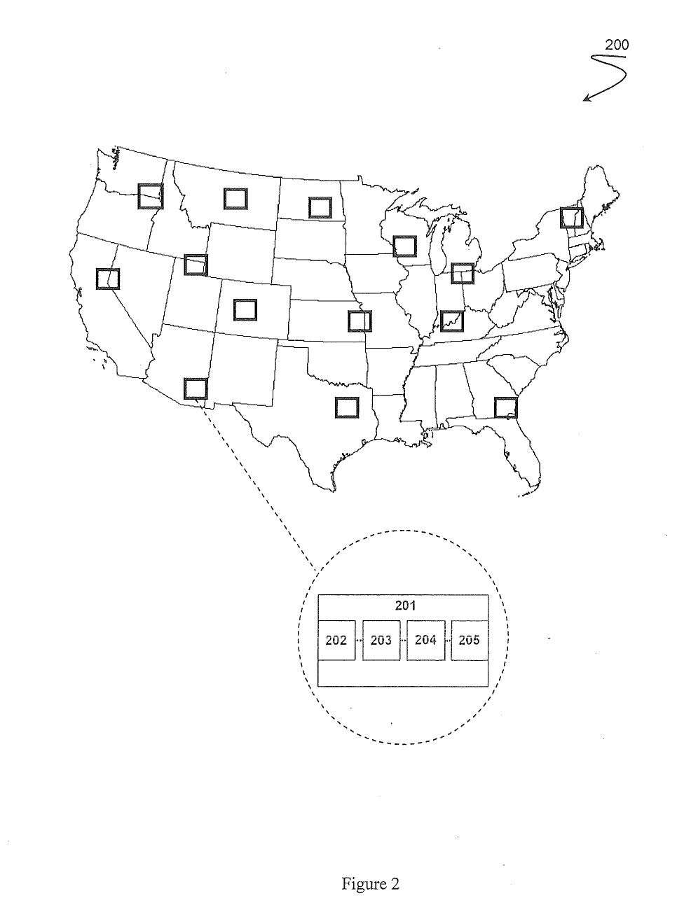

In FIG. 2, a lightning detection system 200 is presented where a plurality of the communication jacks shown in FIG. 1 and described herein are dispersed in various geographic locations. Each of the communication jacks of this system are, as described previously, comprised of a jack housing 201 within which is disposed one or more communication ports 202, sensors 203, sensor data servers 204 and sensor input interfaces 205.

Similar to the communication jack of FIG. 1, each communication jack of the lightning system has a communication port that may comprise any wired port such as an RJ jack, an Ethernet port, a serial port, an RS-232 port, an RS-485 port, a USB port, a FireWire port, a fiber channel, a camera link, a Tunderbolt port, an External PCI Express x16, an IEEE-488 connector, an IEEE-1284 parallel port, a UNI/O bus, a process field bus (PROFIBUS), an ACCESS-bus, a MIDI interface, an Inter-Integrated Circuit (I 2C), or a serial peripheral interface bus (SPI).

Alternatively, one or more of the communication jacks could have one or more communication ports that are wireless ports comprising wireless implementations, devices or standards such as radio, cellular, TETRA, P25, OpenSky, EDACS, DMR, dPMR, DECT, WPAN, Bluetooth, ultra-wideband (UWB), wireless microphones, remote controls, infrared, RFID, TransferJet, Wireless USB, DSRC, EnOcean, near field communication (NFC), wireless LAN, Wi-Fi, HiperLAN, IEEE 802.11, WMAN, LMDS, WiMAX or HiperMAN.

Additionally the one or more servers used in the lightning detection system 200 could comprise at least one of the following: an FTP server, an HTTP server, an application server, a device server, a database server, a fax server, a file server, a name server, a print server, a proxy server, a standalone server, a web server, or an analytics server.

In some embodiments, an analysis server is preferably configured to capture and analyze obtained sensor data. For example, when the sensor data includes lightning discharge information, the data can include time stamps or other metadata which can be used to determine trends, correlations or patterns. In such embodiments, there can be a high level of synchronization among sensors, possible through GPS technology, in order to ensure a high resolution for time stamps or location information.

Additionally, the analysis server could interface with legacy lightning detection systems, including space-based detection systems, for analysis across larger or historic data sets.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A communication jack comprising:
a jack housing comprising mounting points;
a communication port disposed within the jack housing;
a sensor at least partially disposed within the housing; and
a sensor data server disposed within the housing and coupled with the communication port and the sensor, the server configured to obtain sensor data from the sensor and provide access to the sensor data via the communication port.

2. The jack of claim 1, wherein the sensor comprises a lightning sensor.

3. The jack of claim 1, wherein the sensor comprises at least one of the following: a camera, a hall effect sensor, a thermometer, a global positioning system (UPS) sensor, a mechanical sensor, a chemical sensor, a biometric sensor, a microphone, an accelerometer, a pressure sensor, a compass, a magnetometer, a touch display, an optical sensor, a proximity sensor, a vibration sensor, a piezoelectric sensor, a capacitive sensor, a resistive sensor, and a weight sensor.

4. The jack of claim 1, wherein the housing comprises a Faraday housing.

5. The jack of claim 1, wherein the mounting points comprise at least one of the following: ground pins, tabs, and surface mounting points.

6. The jack of claim 1, wherein the communication jack further comprises a sensor input interface.

7. The jack of claim 6, wherein the sensor input interface comprises an antenna.

8. The jack of claim 6, wherein the housing operates as the sensor input interface.

9. The jack of claim 1, wherein the communication port comprises a registered jack (RJ) network interface.

10. The jack of claim 9, wherein the RJ network interface comprises at least one of the following: an RJ11 jack, an RJ14 jack, an RJ21 jack, RJ48 jack, and an RJ45 jack.

11. The jack of claim 1, wherein the communication port comprises a wired port,

12. The jack of claim 11, wherein the wired port comprises at least one of the following: an Ethernet port, a serial port, an RS-232 port, an RS-485 port, RS-422 port, a USB port, a FireWire port, a fiber channel, a camera link, a Thunderbolt port, an PCI Express, an IEEE-488 connector, an IEEE-1284 parallel port, a UNI/O bus, a process field bus (PROFIBUS), an ACCESS-bus, a MIDI interface, an Inter-Integrated Circuit (I 2C), and a serial peripheral interface bus (SPI).

13. The jack of claim 1, wherein the communication port comprises a wireless port.

14. The jack of claim 13, wherein the wireless port operates according to at least one of the following: radio, cellular, TETRA, P25, OpenSky, EDACS, DMR, dPMR, DECT, WPAN, Bluetooth, ultra-wideband (UWB), RFID, TransferJet, Wireless USB, DSRC, EnOcean, near field communication (NFC), wireless LAN, Wi-Fi, HiperLAN, IEEE 802.11, WMAN, LMDS, WiMAX and HiperMAN

15. The jack of claim 1, wherein the server comprises at least one of the following: an FTP server, an HTTP server, an application server, a communications server, a database server, a fax server, a file server, a device server, a name server, a print server, a proxy server, a web server, and an analytics server.

16. A lightning detection system comprising:
a plurality of communication jacks, each jack including a communication port and a lightning sensor at least partially disposed in a common jack housing having mounting point; and
at least one server coupled with the plurality of communication jacks and configured to provide access to lightning sensor data from the lightning sensor via the communication port of at least one of the plurality of communication jacks.

17. The system of claim 16, wherein the common jack housing comprises a Faraday housing.

18. The system of claim 16, wherein at least one of the communication jacks further comprises a sensor input interface.

19. The system of claim 18, wherein the housing operates as the sensor input interface.

20. The system of claim 16, wherein the communication port comprises a registered jack (RJ) network interface.
